(19) United States
(12) Patent Application Publication
(10) Pub. No.: US 2014/0129933 A1
(43) Pub. Date: May 8, 2014

(54) USER INTERFACE FOR INPUT FUNCTIONS

(71) Applicant: Syntellia, Inc., San Francisco, CA (US)

(72) Inventor: Kostas Eleftheriou, San Francisco, CA (US)

(73) Assignee: Syntellia, Inc., San Francisco, CA (US)

(21) Appl. No.: 14/070,368

(22) Filed: Nov. 1, 2013

Related U.S. Application Data
(60) Provisional application No. 61/724,192, filed on Nov. 8, 2012.

(51) Int. Cl. G06F 3/0488; G06F 3/01

(52) U.S. Cl. CPC G06F 3/04886; G06F 3/016
USPC 715/702; 715/773

(57) ABSTRACT

An electronic device includes a touch screen for inputting text and hardware buttons for performing functions. A user inputs a sequence of letters and then actuates the hardware button which causes the system to perform an auto-correction if the input text is not recognized as a word and a space after the word. The hardware button can have multiple actuation modes including a touch actuation and a depression actuation. Each actuation mode can perform different system functions.

### CROSS REFERENCE TO RELATED APPLICATIONS

This application claims priority to U.S. Provisional Patent Application No. 61/724,192, “User Interface For Input Functions” filed Nov. 8, 2012, the contents of which are hereby incorporated by reference in its entirety.

### FIELD OF INVENTION

This invention relates to user interfaces and in particular to text input.

### BACKGROUND OF THE INVENTION

The present invention relates to devices capable of recording finger movements. Such devices include, for example, computers and phones featuring touch screens, or other recording devices able to record the movement of fingers on a plane or in three dimensional spaces.

A number of devices where finger interaction is central to their use have recently been introduced. They include mobile telephones (such as the Apple iPhone, the Samsung Galaxy S), tablet computers (such as the Apple iPad, or the Amazon Kindle), as well as a range of mobile computers, smart watches, PDAs and satellite navigation assistants. The growth in the use of smartphones and tablets in particular has accelerated the introduction of touch screen input for many users and uses.

In some devices featuring a touch screen, it is common for systems to emulate a keyboard text entry system. The devices typically display a virtual keyboard on screen, with users tapping on the different letters to input text. The lack of tactile feedback in this typing process means that users are typically more prone to errors than when they type on hardware keyboards.

It is common on hardware keyboards to include both input keys such as number and letter keys and function keys such as space bar, the backspace key, the shift key, the caps lock key, etc. The input keys and function keys can occupy the same physical space on the hardware keyboard. To date, most software based virtual keyboards have emulated the same design. Because of the lack of tactile feedback, and because of the size of mobile devices often being smaller than the typical desktop computer, software keyboard users are more error prone and tend to accidentally press these function keys while typing.

Some software keyboards attempt to address this problem by providing visual feedback to the user as they press the virtual buttons on a screen. This might be by highlighting a button as it is pressed. These visual aids, though often helpful, have generally not been sufficient to provide the same ease of use on software keyboards that is typical on hardware ones.

The present invention describes functions allowing users a more intuitive interaction with a software keyboard, and utilizing some functionality made possible with interfaces such as touch-screens, or devices which combine hardware buttons with a screen display. The resulting system is considerably easier to use and provides a much more comfortable typing experience.

### SUMMARY OF THE INVENTION

The present invention is directed towards a mobile device that includes a touch screen input and display. The mobile device can also include one or more hardware buttons which can be physically actuated by the user. The touch screen can display a keyboard and touching the keyboard can cause the system to input and display the text. The hardware button can be actuated by the user to preform program functions that may be useful for the text input. For example, in an embodiment, the hardware button can be actuated to indicate that the input word is complete. Thus, after the user has input a sequence of letters, the user can actuate a hardware button indicating the word is complete. The system analyze the text input and determine if the word is properly spelled. If the input sequence of letters is not recognized, the system can perform a word correction function and then input a space after the word. If the input letters are recognized as a word, the system can input a space after the word. The user can input the next word and the process can be repeated until all of the desired text is input.

In other embodiments, the hardware button(s) can have multiple actuation modes. For example, a hardware button on a device may detect the touch in a first actuation mode and the depression of the button in a second actuation mode. The system can perform different functions based upon the type of actuation detected. For example, in an embodiment, the system can perform the space and/or auto-correction function when the touch actuation is detected by the button. However, when the button is pressed into the device, the system can perform a completely different function such as displaying a menu for the program or application that is running on the device. In other embodiments, the mobile device may have multiple keyboards which can include for example: a normal keyboard in a QWERTY layout, a keyboard in a DVORAK layout, a symbols keyboard, etc. The hardware button can be actuated to change the displayed the displayed keyboard. Each keyboard can be displayed in a repeating loop so that an keyboard can be displayed by pressing the hardware button.

In an embodiment, the inventive system can provide enhanced visual feedback for each character typed on the virtual keyboard on the touch screen. Rather than highlighting just the area of the keyboard in the immediate proximity of the letter being typed, the inventive system can highlight portions of the keyboard that extend to the letters adjacent to the letter being typed. Thus, the areas between the adjacent letters can be part of the highlighted feedback when either of the adjacent letters is typed on the virtual keyboard. In an embodiment, the inventive system can analyze the input text and determine the most likely intended letter if the user touches the area between two adjacent letters. The analysis can be based upon the prior letters input and the most likely subsequent letter to spell an intended word.

### BRIEF DESCRIPTION OF THE DRAWINGS

FIG. 1 illustrates an embodiment of a device that includes a virtual keyboard displayed on a touch screen and hardware buttons;

FIG. 2 illustrates a block diagram of system components;

FIG. 3 illustrates an embodiment of a mobile device that includes a virtual keyboard displayed on a touch screen and hardware buttons;

FIG. 4 illustrates an embodiment of a smart watch device that includes a virtual keyboard displayed on a touch screen and hardware buttons;

FIG. 5 illustrates a illustrates an embodiment of a mobile device that includes a virtual keyboard displayed on a touch screen and a multiple function hardware button;

FIGS. 6 and 7 illustrate cross sectional views of an embodiment of a multiple function hardware button;

FIGS. 8-10 illustrate a mobile device displaying different keyboards on a touch screen; and

FIGS. 11 and 12 illustrate a mobile device with a virtual keyboard enhanced highlight feedback.

### DETAILED DESCRIPTION OF THE INVENTION

The invention describes a device comprising a display capable of presenting a virtual keyboard, an area where the user input text can be displayed, and a touch-sensitive controller such as a touch pad or a touch screen. However, in other embodiments, a screen or a touch-sensitive controller may not be required to perform the method of the claimed invention. For example, in an embodiment, the input device can simply be the user's body or hands and a controller that is able to understand the user's finger movements in order to produce the desired output. The output can be either on a screen or through audio signals. For example, the input device may be a camera such as a Microsoft Kinect controller that is directed at the user. The cameras can detect the movement of the user and the output can be transmitted through speakers or other audio devices such as headphones. Optionally, the output can be transmitted through an output channel capable of audio playback, such as speakers, headphones, or a hands-free ear piece.

In some embodiments, the device may be a mobile telephone, a smart watch or a tablet computer. In such cases, the text display and touch-sensitive controller may both be incorporated in a single touch-screen surface or be a separate component(s). With the inventive system, the user can control the electronic device using the touch-sensitive controller. Typically, the user will use the system to type text in the following manner:

1. Tapping at different letters or letter buttons displayed on the screen, whereby each tap represents the user's intention to press a button on the virtual keyboard.

2. Using a space delimiter function, whereby the user signifies to the system that he intends to add a space character, or that he intends to allow the system to auto-correct his input.

3. Tapping specified function keys on the screen, whereby each tap represents the user's intention to perform the function of the specified key.

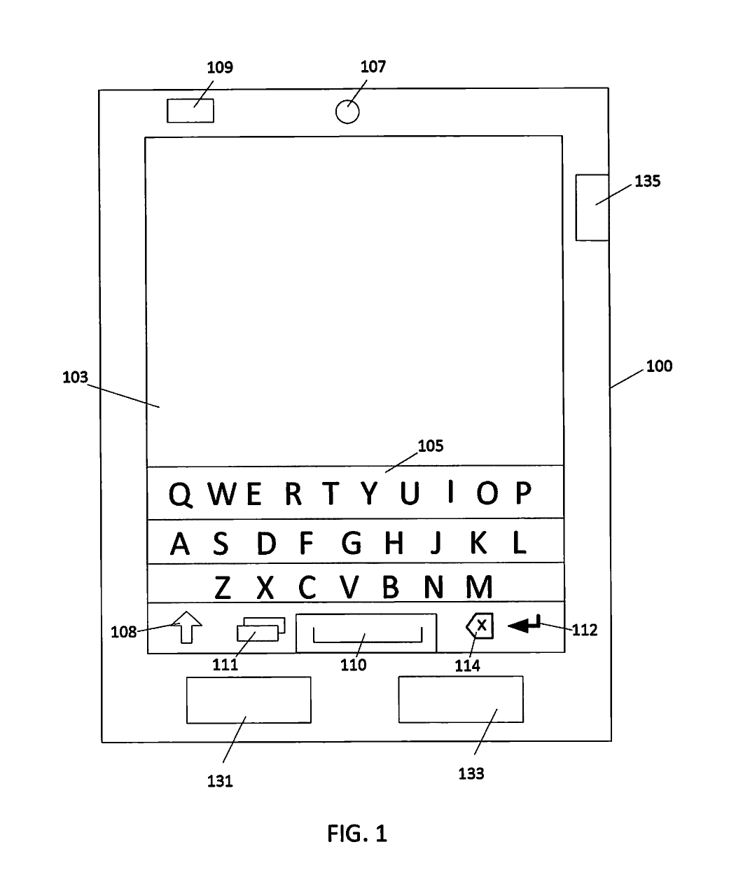

With reference to FIG. 1, a view of an exemplary electronic device 100 is illustrated that implements a touch screen-based virtual keyboard 105. The illustrated electronic device 100 includes a display that also incorporates a touch screen 103. The display 100 can be configured to display a graphical user interface (GUI). The GUI may include graphical and textual elements representing the information and actions available to the user. For example, the touch screen 103 may allow a user to move an input pointer or make selections on the GUI by simply pointing at the GUI on the display 103. In an embodiment, the body or hands of the user can be detected by a camera 107.

The GUI can be adapted to display a program application that requires text input. For example, a chat or messaging application can be displayed through the GUI. For such an application, the input/display can be used to display information for the user, for example, the messages the user is sending, and the messages he is receiving from the person he is communicating with. The input/display can also be used to show the text that the user is currently inputting in text field. The input/display can also include a virtual “send” button(s) 131, activation of which causes the messages entered in text field to be sent to a recipient. The input/display 103 can be used to present to the user a virtual keyboard 105 that can be used to enter the text that appears on the display 103 and the input text is ultimately sent to the person the user is communicating with.

If a virtual keyboard 105 is displayed, touching the touch screen at a “virtual letter key” can cause the corresponding text character to be generated in a text field of the touch screen display 103. The user can interact with the touch screen 103 using a variety of touch objects, including, for example, a finger, stylus, pen, pencil, etc. Additionally, in some embodiments, multiple touch objects can be used simultaneously.

Because of space limitations, the virtual keys on the virtual keyboard 105 may be substantially smaller than keys on a conventional computer keyboard. To assist the user, the system may emit feedback signals that can indicate to the user what key is being pressed. For example, the system may emit an audio signal through a speaker 109 for each letter that is input. Additionally, not all characters found on a conventional keyboard may be present on the virtual keyboard. Such special characters can be input by invoking an alternative virtual keyboard. In an embodiment, the system may have multiple virtual keyboards that a user can switch between based upon pressing special buttons displayed on the screen, or special hardware button(s) 133 on the device 100, or by performing a gesture motion. For example, a virtual key 111 on the touch screen 103 can be used to invoke an alternative keyboard including numbers and punctuation characters not present on the main virtual keyboard 105. Additional virtual keys for various functions may be provided. For example, a virtual shift key 108, a virtual space bar 110, a virtual carriage return or enter key 112, and a virtual backspace key 114 are provided in embodiments of the disclosed virtual keyboard.

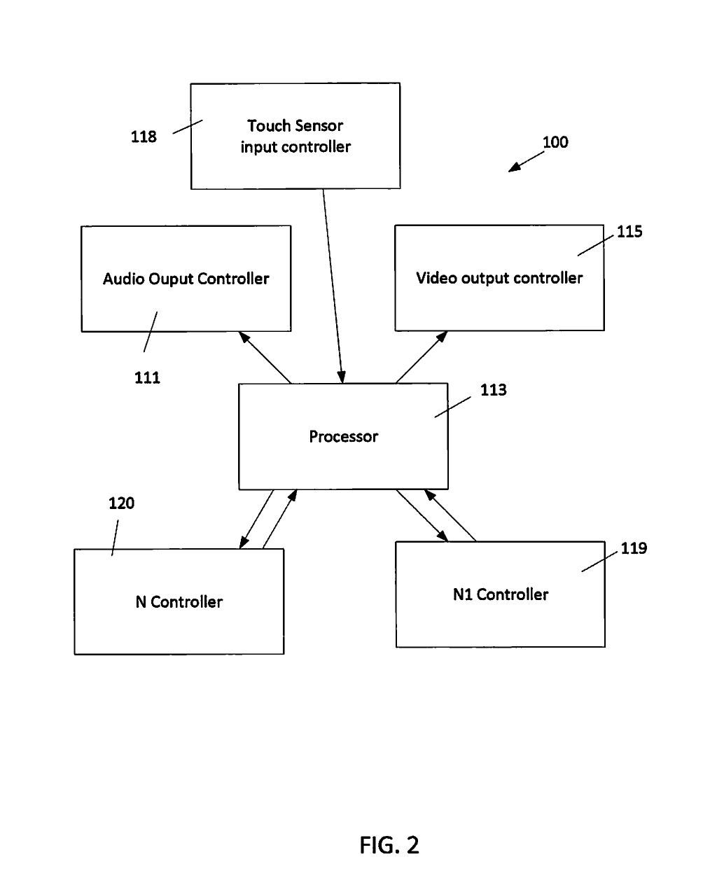

FIG. 2 shows a diagram of a device 100 capable of implementing the current invention. The device 100 may comprise: a touch-sensitive input controller 118, a processor 113, an audio output controller 111 and a video output controller 115. The device 100 may feature a range of other controllers, and may have a wide number of functions.

### Space Delimiter

A typical function of keyboards is that they include a function key designating a space delimiter, shown as a space bar 110 in FIG. 1. The space delimiter is one of the most important buttons of a virtual keyboard because it typically both signifies the intention to enter a space character in the input text, and the intention to invoke the auto-correct function present in the input system. In an embodiment of the present invention, these functions are known as: “space function” and “auto-correct function”.

In a typical QWERTY keyboard configuration (and many other configurations), the space button occupies a large proportion of, or the entire, the fourth row of keys on a hardware or virtual keyboard. On a virtual keyboard interface, this leads to the space key being often pressed by mistake when users attempt to input text including letters or buttons located in proximity to the space button. Conversely, the importance and frequent of use of the space key causes users often accidentally press nearby buttons by mistake when attempting to press the space button.

The inventive system provides an alternative interface whereby a virtual keyboard 105 is displayed in a touch screen 103, and is combined with a hardware button(s) 131, 133, 135 which may be used for the space function and/or the auto-correct function. In an embodiment, only one of the hardware buttons 131, 133, 135 performs the space function and/or the auto-correct function. However, in other embodiments, each of the hardware buttons 131, 133, 135 can perform these functions. This hardware button 131, 133, 135 in combination with a virtual keyboard 105 can lead to considerable improvements on the user interface on a host device 100. Because the virtual space bar may not be displayed because the space bar functionality can be replicated by a hardware button(s) 133, 133, 135 more space can be available on the screen 103 to display other buttons or user interface elements. The inventive system can also provide additional functionality whereby the virtual space button may complement, or extend the functionality of a hardware button 133, 133, 135.

In other embodiments, the presence of a hardware space button 133, 133, 135 may considerably reduce accidental presses of the spacebar which can include false positive and negatives. The nature and texture of a hardware button 133, 133, 135 used can also provide tactile feedback as an additional aid for the user to ensure correct interaction with the appropriate space and auto-correct functions. For instance, a textured, curved, recessed or protruding hardware button 133, 133, 135 may be easier for the user to locate than a virtual button on a smooth touch screen 103.

FIG.2 shows an embodiment of such a system. In this embodiment, a device 100 comprises a touch-screen interface 103 displaying a virtual keyboard 105, and hardware buttons 133, 133, 135. The user can press letter buttons 105 to input text can use the touch screen 103 interface. The user may also press one of the hardware buttons 133, 133, 135 to signify both the space function and auto correct function to the system. In this embodiment, the touch screen 103 is not displaying a space bar to the user, as these are functions are performed by the hardware button 133, 133, 135.

In some embodiments as shown in FIG. 1, the virtual keyboard 105 may display a space bar 110. In these embodiments, the functions of the hardware button 133, 133, 135 may complement, rather than replace the function of the on screen space button 110. Alternatively, the functions of the hardware button 133, 133, 135 may be identical to those of on-screen space bar 110 and/or other buttons.

In other embodiments, the virtual keyboard 105 may display a space button 110 with slightly different functionality from a present hardware button 133, 133, 135. For example, the software button may perform only the space function, while the hardware button may simultaneously perform both the space and the auto-correct functions.

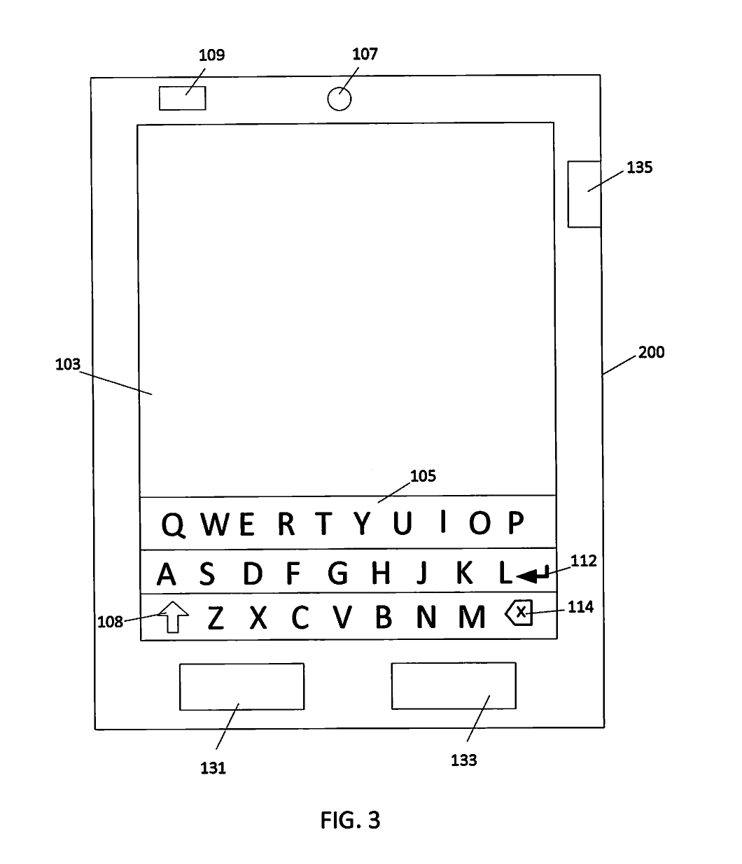

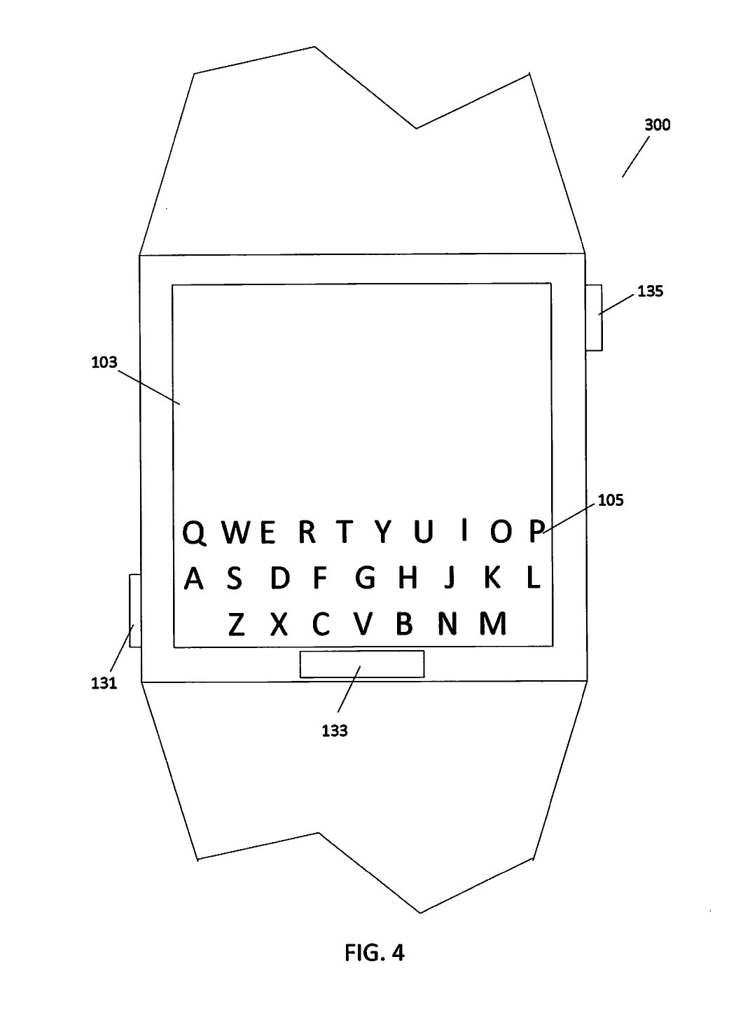

FIGS. 3 and 4 show other embodiments of a device that comprises a touch-screen interface 103 displaying a virtual keyboard 105 and a hardware buttons 131, 133, 135 which can be on the front or sides of the device. FIG. 3A illustrates a portable mobile device 200 and FIG. 3B illustrates a smaller smart watch device 300. The hardware button 131 may feature a switch that is activated when the user presses the button 131 with a certain amount of force.

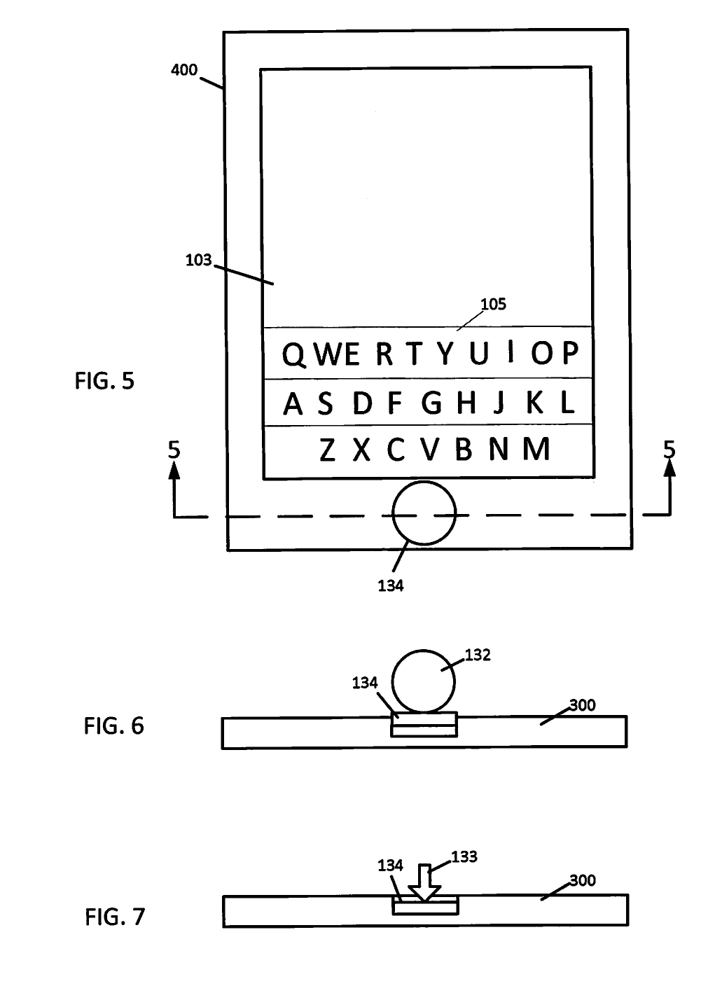

FIG. 5 shows an embodiment of a device 400 that comprises a touch-screen interface 103 displaying a virtual keyboard 105 and a hardware button 134 which can have multiple actuation modes. With reference to FIGS. 6 and 7, the button 134 can include a touch-sensitive surface that is activated when the user touches the button 134 even if the force applied is not enough to press and physically move the button 134 into the device 300. This button 134 can be capable of registering two different types of events, “touch events” which occur when the button is touched and not pressed as shown in FIG. 6. In an embodiment, the button 134 can include a sensor such as a proximity or infrared heat sensor which can detect when an appendage such as a finger 132 is in contact with the button 134. In contrast the “touch events”, the “press events” occur when the button 134 is physically pressed into the device 300 with a force 133 as shown in FIG. 7.

In certain embodiments, the inventive system will distinguish between the touch and press types of events, and perform the space function or autocorrect function based upon the type of event detected by the system. For example, “touch events” may be interpreted by the system as the user's intention to perform one of or both the “space” and “auto-correct” functions, while “press events” may be reserved for other system functionality. For example, the touch event can input a space and/or auto-correction function while a full click can be input to display a program menu.

By combining two types of sensors on the single hardware button 134, the system illustrated in FIGS. 5, 6 and 7 may be introduced as a user interface upgrade to existing systems. Such systems may have used a hardware button with a switch sensor only in previous generations, and could complement their existing functionality with additional functionality by adding a second type of sensor to the same button 134.

Where the described dedicated hardware buttons and/or sensors may also be used for other system functions which may be unrelated to typing and the user interaction with the dedicated hardware may indicate that the desired function is different than typing text input. For example, a single click on the hardware button may invoke the auto-correct function and a double click on a hardware button may invoke a menu for the program or application running on the system.

### Keyboard Control

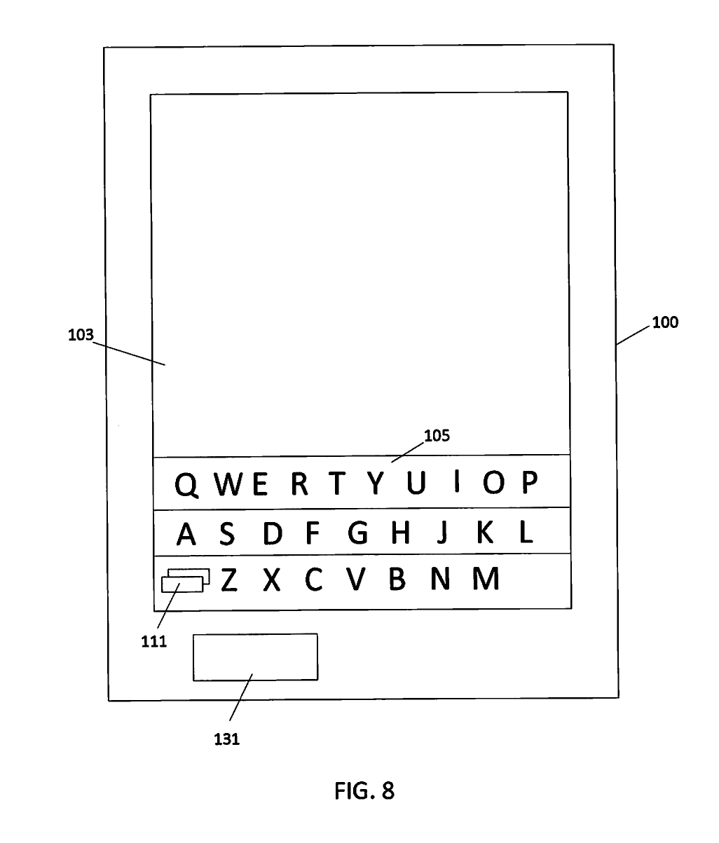

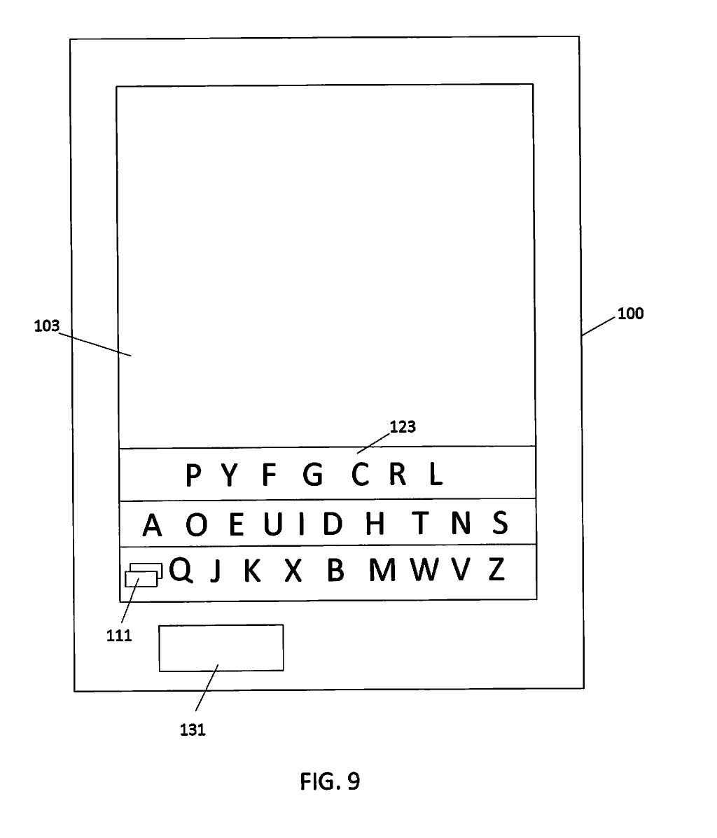

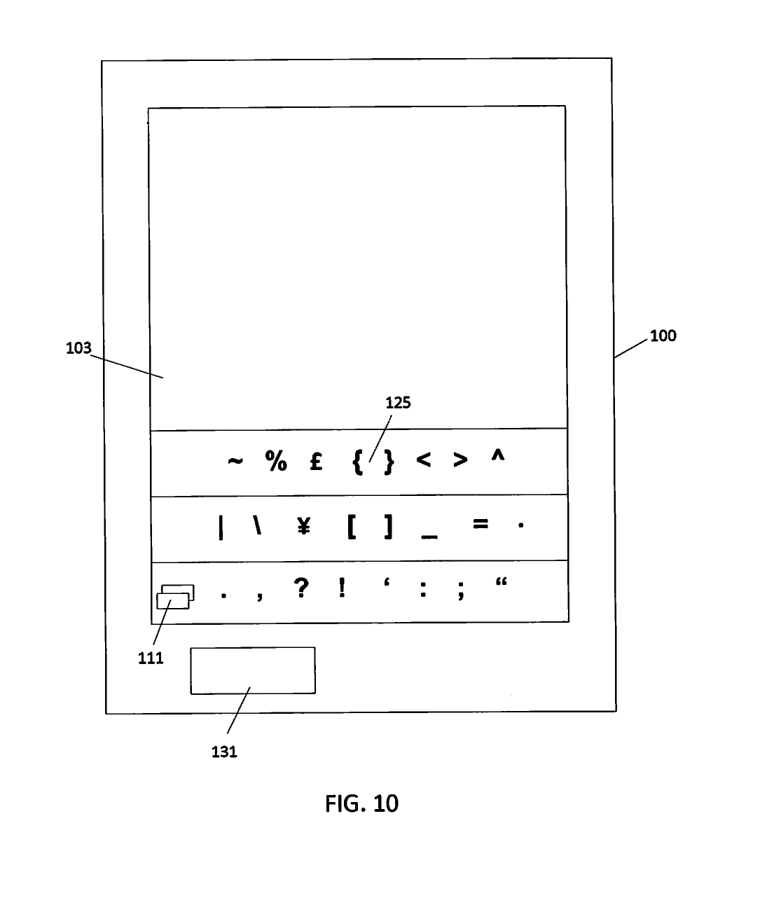

As discussed, the device 400 can include a keyboard 105 displayed on screen 103 as shown in FIG. 8. When the user is not interacting with the device 400, the screen 103 shows the typical characters of a QWERTY keyboard 105. The user may be able to switch between different keyboards by actuating a hardware button 131 or a keyboard change function button 111 on the display 103. In other embodiments, the keyboard may additionally display function keys. With reference to FIGS. 9 and 10, the actuation of the hardware button 131 and/or the keyboard change function button 111 can result in the display 103 showing a different keyboard layout. FIG. 9 illustrates a DVORAK keyboard 123 and FIG. 10 illustrates a symbols keyboard 125. In an embodiment, repeated pressing of the hardware button 131 and/or the keyboard change function button 111 can cause the system to display the various keyboards in a repeating loop. Again, the hardware button can allow the space on the display to be used for text input and text display rather than functional controls. This can be particularly important for devices having small displays such as smart watches.

### Button Display

A typical functionality of a software virtual keyboard can include providing feedback to the user when they press a button on the display screen. This visual feedback typically comprises highlighting a pressed virtual button, either by changing the color or typeface displayed on screen, or by “popping up” the button so an enlarged version is displayed on the screen.

The inventive system can use different display methods for performing this functionality. For example, rather than highlighting the buttons on screen using the existing display size or instantaneously changing the display, the inventive system can enlarge the displayed button as it is pressed in an animated fashion. In contrast with other systems, the inventive system departs from the metaphor of a “hardware button” displayed in analogy on the screen. The inventive system uses a “buttonless” interface, while still offering the visual feedback that resembles a buttons when interacting.

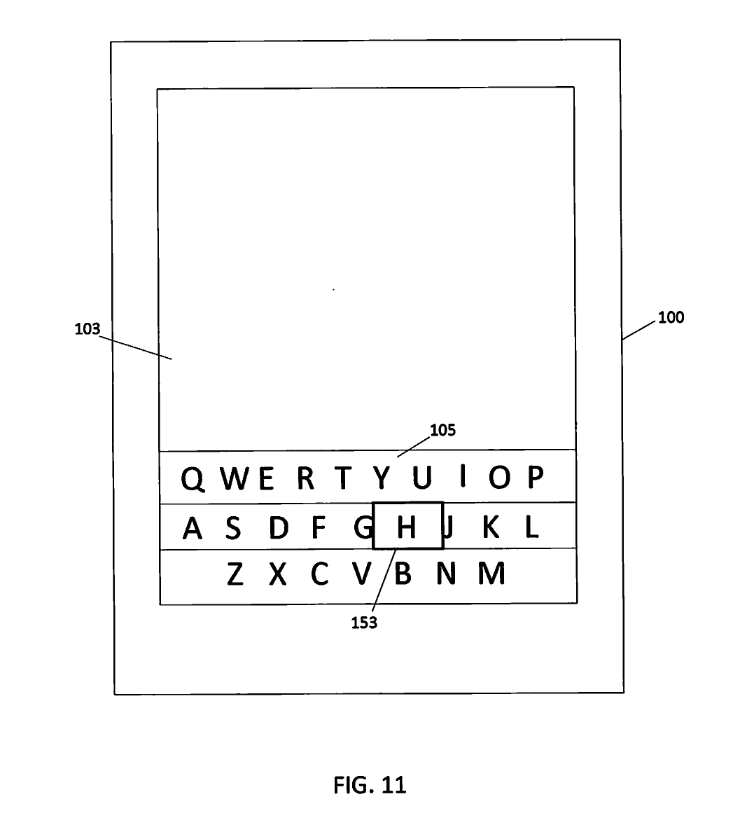

For example, with reference to FIG. 11 shows the effect of the user pressing on button H. A normal virtual keyboard may have substantially equal “active areas” of the keyboard 105 associated with each displayed letter, number, punctuation mark and symbol. When a user touches the keyboard 105 in the active area, the corresponding letter, number, punctuation mark or symbol is input and displayed. However, in an embodiment of the present invention, rather than highlighting the normal “active area” for the letter H, the inventive system highlights a larger feedback area 153 than the active area for the letter H. The feedback area 153 can be expanded along the horizontal axis, so that the highlighted feedback area 153 appears to “cover” portions of the active areas of the adjacent letters. In this example, the larger feedback area 153 extends over the active areas for the letter G and the letter J.

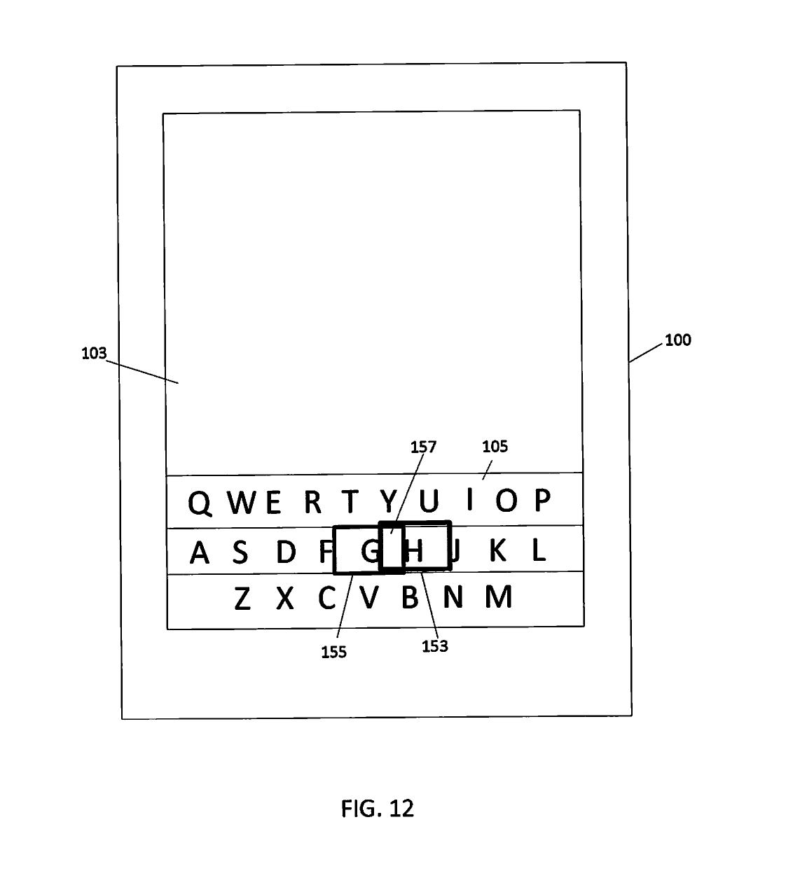

FIG. 12 shows the effect of the user pressing on the button G. The inventive system highlights a feedback area 155 for the button G in a similar way with a larger feedback area 153 for the letter H. Note that the space 157 between the letters G and H is highlighted when the user presses the H key as shown in FIG. 11 and when the user presses the G key as shown in FIG. 12.

The inventive system has some considerable advantages over other feedback systems used by virtual keyboards. For example, on smartphones, smart watches and tablet devices, the user is often constrained on the horizontal axis. The display effect of the inventive system gives the user the illusion of a larger area per key, and a larger typing space. Additionally, the inventive system gives the user feedback consistent with the actual behavior of many auto-correct systems. Many such systems enlarge the “catchment area” of buttons as the user types to aid typing which provides functionality which can be termed “key-charging.” This display effect will also help the user understand that they can rely more on such auto-correct systems. The catchment area of the button may or may not be the same as the highlighted area when a button is pressed.

When the user taps on a “common” or shared highlighted key area such as the space 157 between letters shown in FIG. 12, the system can decide which of the two adjacent buttons is more likely to have been the intended one based upon the context of the letters or word being typed. For example, if the user has typed the text, “Flyin”, the system can determine that G is the most likely the intended letter if the user touches the space 157 between G and H.

It will be understood that the inventive system has been described with reference to particular embodiments, however additions, deletions and changes could be made to these embodiments without departing from the scope of the inventive system. Although the order filling apparatus and method have been described include various components, it is well understood that these components and the described configuration can be modified and rearranged in various other configurations.

What is claimed is:

1. An input method, comprising:
a computer system having a processor operatively coupled to a memory, a touch screen interface comprising a virtual keyboard which records taps of a touch object to generate text input and a hardware button;
tapping the virtual keyboard to input a first plurality of letters which are displayed sequentially on the touch screen;
actuating the hardware button to input a space which is displayed after the first plurality of letters; and
tapping the virtual keyboard to input a second plurality of letters which are displayed sequentially on the touch screen after the space.

2. The input method of claim 1 wherein the hardware button is an electrical switch.

3. The input method of claim 1 wherein the hardware button is a touch sensitive mechanism that is distinct from the touch screen.

4. The input method of claim 1 wherein the hardware button is an electrical switch and the computer system includes a second hardware button that is a touch sensitive mechanism that is distinct from the touch screen.

5. The input method of claim 1 further comprising:
providing tactile feedback when the hardware button is actuated.

6. An input method, comprising:
a computer system having a processor operatively coupled to a memory, a touch screen interface comprising a virtual keyboard which records taps of a touch object to generate text input and a hardware button;
tapping the virtual keyboard to input a first plurality of letters which are displayed sequentially on the touch screen;
actuating the hardware button to perform an auto correct function on the first plurality of letters to change the first plurality of letters to a first corrected word;
removing the first plurality of letters from the touch screen; and
displaying the first corrected word on the touch screen.

7. The input method of claim 6 wherein the hardware button is an electrical switch.

8. The input method of claim 6 wherein the hardware button is a touch sensitive mechanism that is distinct from the touch screen.

9. The input method of claim 6 wherein the hardware button is an electrical switch and the computer system includes a second hardware button that is a touch sensitive mechanism that is distinct from the touch screen.

10. The input method of claim 6 further comprising:
providing tactile feedback when the hardware button is actuated.

11. An input method, comprising:
a computer system having a processor operatively coupled to a memory, a touch screen interface comprising a virtual keyboard which records taps of a touch object to generate text input and a hardware button;
tapping the virtual keyboard to input a first plurality of letters which are displayed sequentially on the touch screen;
actuating the hardware button to perform letter delete function on the first plurality of letters;
removing a last letter input of the first plurality of letters from the touch screen; and
tapping the virtual keyboard to add a replacement letter to the first plurality of letters which is displayed on the touch screen.

12. The input method of claim 11 wherein the hardware button is an electrical switch.

13. The input method of claim 11 wherein the hardware button is a touch sensitive mechanism that is distinct from the touch screen.

14. The input method of claim 11 wherein the hardware button is an electrical switch and the computer system includes a second hardware button that is a touch sensitive mechanism that is distinct from the touch screen.

15. The input method of claim 11 further comprising:
providing tactile feedback when the hardware button is actuated.

16. An input method, comprising:
a computer system having a processor operatively coupled to a memory, a touch screen interface comprising a virtual keyboard which records taps of a touch object to generate text input and a hardware button;
tapping the virtual keyboard to input a first plurality of letters which are displayed sequentially on the touch screen;
actuating the hardware button to perform a word delete function on the first plurality of letters;
removing the first plurality of letters from the touch screen; and
tapping the virtual keyboard to input a second plurality of letters which are displayed sequentially on the touch screen.

17. The input method of claim 16 wherein the hardware button is an electrical switch.

18. The input method of claim 16 wherein the hardware button is a touch sensitive mechanism that is distinct from the touch screen.

19. The input method of claim 16 wherein the hardware button is an electrical switch and the computer system includes a second hardware button that is a touch sensitive mechanism that is distinct from the touch screen.

20. The input method of claim 16 further comprising:
providing tactile feedback when the hardware button is actuated.

21. An input method, comprising:
a computer system having a processor operatively coupled to a memory, a touch screen interface comprising a virtual keyboard which records taps of a touch object to generate text input and a hardware button;
tapping the virtual keyboard to input a first plurality of letters which are displayed sequentially on the touch screen;
actuating the hardware button to input a punctuation mark which is displayed after the first plurality of letters; and
tapping the virtual keyboard to input a second plurality of letters which are displayed sequentially on the touch screen after the space.

22. The input method of claim 21 wherein the hardware button is an electrical switch.

23. The input method of claim 21 wherein the hardware button is a touch sensitive mechanism that is distinct from the touch screen.

24. The input method of claim 21 wherein the hardware button is an electrical switch and the computer system includes a second hardware button that is a touch sensitive mechanism that is distinct from the touch screen.

25. The input method of claim 21 further comprising:
providing tactile feedback when the hardware button is actuated.

26. An input method, comprising:
a computer system having a processor operatively coupled to a memory, a touch screen interface comprising a virtual keyboard which records taps of a touch object to generate text input and a hardware button;
tapping the virtual keyboard to input a first plurality of letters which are displayed sequentially on the touch screen;
actuating the hardware button to perform a word delete function on the first plurality of letters;
removing the first plurality of letters from the touch screen; and
tapping the virtual keyboard to input a second plurality of letters which are displayed sequentially on the touch screen.

27. The input method of claim 26 wherein the hardware button is an electrical switch.

28. The input method of claim 26 wherein the hardware button is a touch sensitive mechanism that is distinct from the touch screen.

29. The input method of claim 26 wherein the hardware button is an electrical switch and the computer system includes a second hardware button that is a touch sensitive mechanism that is distinct from the touch screen.

30. The input method of claim 26 further comprising:
providing tactile feedback when the hardware button is actuated.

31. An input method, comprising:
a computer system having a processor operatively coupled to a memory, a touch screen interface comprising a virtual keyboard which records taps of a touch object to generate text input, a hardware button and an output controller for controlling the touch screen and an audio output;
displaying the virtual keyboard on the touch screen, wherein each letter occupies approximately an equal area on the virtual keyboard;
tapping the virtual keyboard to input a first plurality of letters which are displayed sequentially on the touch screen;
providing visual feedback to the tapping the virtual keyboard for each of the first plurality of letters;
actuating the hardware button to cause the output controller to provide feedback through the audio output mechanism;
tapping the virtual keyboard to input a second plurality of letters which are displayed sequentially on the touch screen; and
providing the audio feedback to the tapping the virtual keyboard for each of the second plurality of letters.

32. The input method of claim 31 wherein the hardware button is an electrical switch.

33. The input method of claim 31 wherein the hardware button is a touch sensitive mechanism that is distinct from the touch screen.

34. The input method of claim 31 wherein the hardware button is an electrical switch and the computer system includes a second hardware button that is a touch sensitive mechanism that is distinct from the touch screen.

35. The input method of claim 31 further comprising:
providing tactile feedback when the hardware button is actuated.
